(19) United States
(12) Patent Application Publication
(10) Pub. No.: US 2017/0146561 A1
(43) Pub. Date: May 25, 2017

(54) WEARABLE ELECTRONIC DEVICE COMMUNICATION

(71) Applicant: Lenovo (Beijing) Limited, Beijing (CN)

(72) Inventors: Weifeng Zhuang, Beijing (CN); Yongfeng Liu, Beijing (CN)

(21) Appl. No.: 15/084,077

(22) Filed: Mar. 29, 2016

(30) Foreign Application Priority Data
Nov. 23, 2015 (CN) 201510818402.7

(51) Int. Cl. G01P 13/00; A43B 3/00; A41D 1/00

(52) U.S. Cl. CPC G01P 13/00; A41D 1/002; A43B 3/0005

(57) ABSTRACT

One embodiment provides a method, including: receiving, at electronic device, data from a wearable device; detecting that the received data relate to a sensor event of at least one sensor of the electronic device, the sensor event being generated and operable to effect an operation of the electronic device via an operating system of the electronic device; and effecting the operation of the electronic device based on the sensor event via the operating system. Other aspects are described and claimed.

### CLAIM FOR PRIORITY

This application claims priority to Chinese Application No. 201510818402.7, filed on Nov. 23, 2015, which is fully incorporated by reference herein.

### FIELD

The subject matter described herein relates to information processing technologies, and in particular to an information processing method and a related electronic device.

### BACKGROUND

Wearable smart devices, such as smart bracelets, smart watches and smart shoes, have become indispensable to people's life and work. Through the cooperative interaction between a wearable device and a terminal device, such as a mobile phone or a tablet, not only monitoring of the motion status and physiological parameters of a user, such as the number of steps taken in one day and changes in blood pressure, can be implemented, complex operations on the terminal device by the user through the wearable device can also be done. For example, stepping positions of a user collected by smart shoes can be used to operate applications of motion-sensing games in a mobile phone; that is, stepping positions of a user can be used to simulate operational actions for applications of motion-sensing games. At present, one may develop a set of special motion-sensing game applications or upgrade existing motion-sensing game applications, so as to enable the motion-sensing game applications in a mobile phone to receive stepping operational actions of a user to be collected by smart shoes and respond accordingly. However, both methods increase the workload and cost required in developing software applications, and are poorly implemented and of poor feasibility.

### BRIEF SUMMARY

In order to solve the technical problems in the prior art, embodiments of the present invention provide an information processing method and a related electronic device. Without the need to modify an application, the present invention enables an application to respond to operations via motion-sensing technology, avoiding unnecessary application development, providing a more robust implementation and a more feasible practice.

In summary, one aspect provides a method, comprising: receiving, at an electronic device, data from a wearable device; detecting that the received data relate to a sensor event of at least one sensor of the electronic device, the sensor event being generated and operable to effect an operation of the electronic device via an operating system of the electronic device; and effecting the operation of the electronic device based on the sensor event via the operating system.

Another aspect provides an electronic device, comprising: a processor; a memory device that stores an operating system comprising instructions executable by the processor; at least one sensor coupled to the processor, the at least one sensor being operable to generate a sensor event to the operating system in order to effect an operation of the electronic device; and a receiver coupled to the processor, the receiver being configured to receive data from a wearable device, wherein the instructions executable by the processor comprise instructions executable by the processor to detect that the data received from the receiver relate to the sensor event of the at least one sensor, and to effect the corresponding operation of the electronic device based on the sensor event via the operating system.

A further aspect provides a wearable device, comprising: a processor; a motion sensor operatively connected to the processor, the motion sensor collating motion data of the wearable device; a transmitter operatively connected to the processor, the transmitter transmitting data to an electronic device; and a memory device that stores instructions executable by the processor to: generate a sensor event based on the collated motion data, wherein the sensor event is of a type of sensor event that is processed by the electronic device; and transmit the sensor event to the electronic device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION ON THE SEVERAL VIEWS OF THE DRAWING

FIG. 1 is a flowchart of a first embodiment of an information processing method applied to a second electronic device;

FIG. 2 is a flowchart of a first embodiment of an information processing method applied to a first electronic device;

FIG. 3 is a flowchart of a second embodiment of an information processing method applied to a second electronic device;

FIG. 4 is a flowchart of a second embodiment of an information processing method applied to a first electronic device;

FIG. 5 is a schematic drawing of a first service and a first;

FIG. 6 is a flowchart of a third embodiment of an information processing method applied to a second electronic device;

FIG. 7 is a flowchart of a third embodiment of an information processing method applied to a first electronic device;

FIG. 8 is a schematic drawing of a first electronic device; and

FIG. 9 is a schematic drawing of a second electronic device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In all the embodiments where information processing methods and electronic devices are described, the related first electronic devices include, but are not limited to, various types of computers, such as industrial control computers, personal computers, integrated computers, tablet PCs, mobile phones, E-readers, etc. The related second electronic devices include, but are not limited to, wearable electronic devices, such as smart shoes, smart glasses, smart gloves, smart watches, smart bracelets, and smart clothing. In embodiments the first electronic device is a mobile phone, whereas the second electronic device is a pair of smart shoes.

### Embodiment 1

In a first embodiment of an information processing method applied to a second electronic device, the second electronic device is capable of performing a first communication wirelessly with a first electronic device via a communications protocol such as BLUETOOTH or WiFi. (BLUETOOTH is a registered trademark of Bluetooth SIG, Inc. in the United States and other countries. WiFi is a registered trademark of the Wi-Fi Alliance in the United States and other countries.) The second electronic device may be a wearable electronic device.

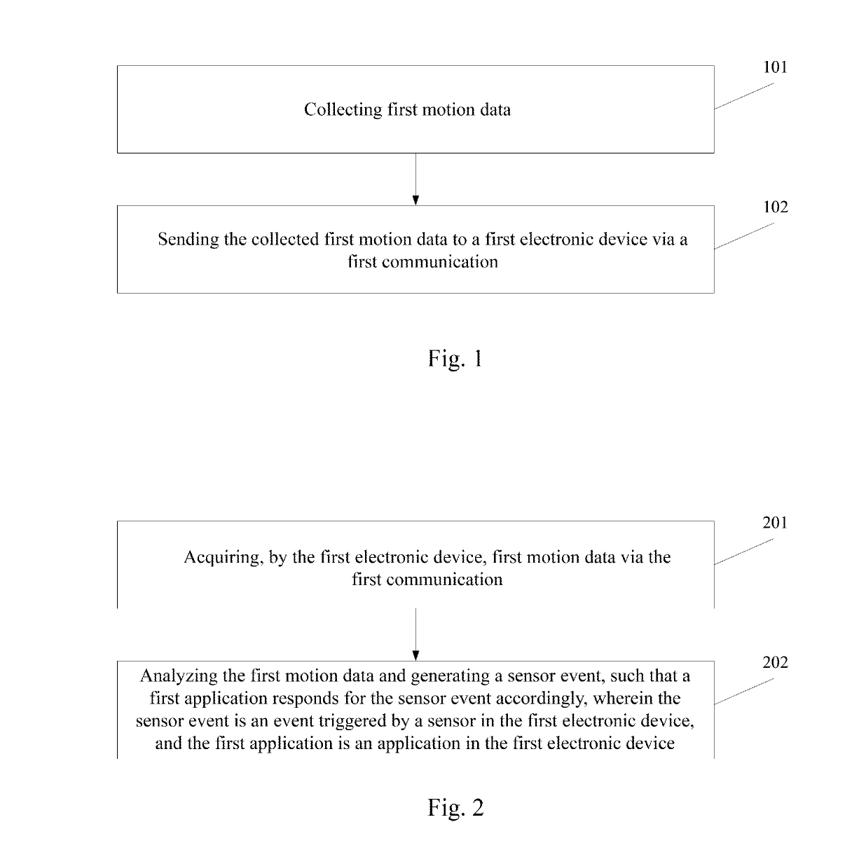

FIG. 1 is a flowchart of a first embodiment of an information processing method applied to a second electronic device. As shown in FIG. 1, the method comprises:

Step 101: Collecting first motion data. Herein, smart shoes are taken as an example for the second electronic device. When a user performs a stepping action (motion-sensing operation), the smart shoes collect data of this action.

Step 102: Sending the collected first motion data to a first electronic device via a first communication. Herein, the collected action data is sent to the first electronic device via the first communication.

In the first embodiment of the information processing method applied to the first electronic device, the first electronic device is capable of performing a first communication wirelessly with a second electronic device via BLUETOOTH or WiFi. In this embodiment, the first electronic device can respond to a motion-sensing operation sent by the second electronic device without the need to modify the application run in the first electronic device.

FIG. 2 is a flowchart of a first embodiment of an information processing method applied to a first electronic device. As shown in FIG. 2, the method comprises:

Step 201: acquiring, by the first electronic device, first motion data via the first communication.

Herein, a wearable electronic device, such as smart shoes, is taken as an example for a second electronic device. When the smart shoes collect motion data generated from a user's stepping motion, the smart shoes send the collected first motion data to the first electronic device via BLUETOOTH or WiFi communication established between the smart shoes and the first electronic device. The first electronic device receives the first motion data. The first motion data comprises at least the direction and velocity, or the direction and acceleration of the user's step motion.

Step 202: analyzing the first motion data and generating a sensor event, such that a first application responds to the sensor event, wherein the sensor event is an event triggered by a sensor in the first electronic device, and the first application is an application in the first electronic device.

Because one or more applications may be run in the first electronic device, the first application may preferably be an application running at top level. Those skilled in the art would know that the application running at top level is an application displayed on the display interface of the first electronic device. The first electronic device analyzes the first motion data and obtains a sensor event, wherein the sensor event may be considered as an operational event (e.g., swipe upward/downward or swipe leftward/rightward) for the application running at top level; the application running at top level responds to the sensor event when the sensor event is detected. For example, a user's step motion received by the first electronic device is a large step taken forward by the user, the sensor event obtained after analyzing the first motion data is that the action of the large step taken forward by the user means a swipe upward operation on a display screen, and the first application detects the swipe upward operation and responds accordingly. Taking ‘Temple Run’ as an example for the first application, a running man in this application may perform a jumping action when a swipe upward operation occurs. ‘Temple Run’ is a video game from OImangi Studios, Raleigh, N.C., USA. Sensors in the first electronic device include, but are not limited to, an acceleration sensor, a gyroscope, an electronic compass, etc. When these various types of sensors detect corresponding motion parameters in the first motion data, for example, when acceleration is detected by the acceleration sensor, generation of a sensor event is triggered.

In an embodiment, the first electronic device receives and analyzes the first motion data acquired via the first communication with the second electronic device, and obtains a sensor event seen as a touchscreen operation to the first application; the first application detects the sensor event and responds accordingly. It can be seen that the first electronic device, according to this embodiment, converts the user's motion data to the sensor event. For the first application, the sensor event is equivalent to a touchscreen operation the user initiates directly on the display screen of the first electronic device. Therefore, the first application can detect the sensor event correctly and respond without the need to modify or upgrade the first application. Unnecessary developments to the applications can be avoided, thereby providing a more robust implementation and a more feasible practice.

### Embodiment 2

In a second embodiment of an information processing method applied to a second electronic device according to the present invention, the second electronic device is capable of performing a first communication wirelessly with a first electronic device via BLUETOOTH or WiFi. The second electronic device may be a wearable electronic device.

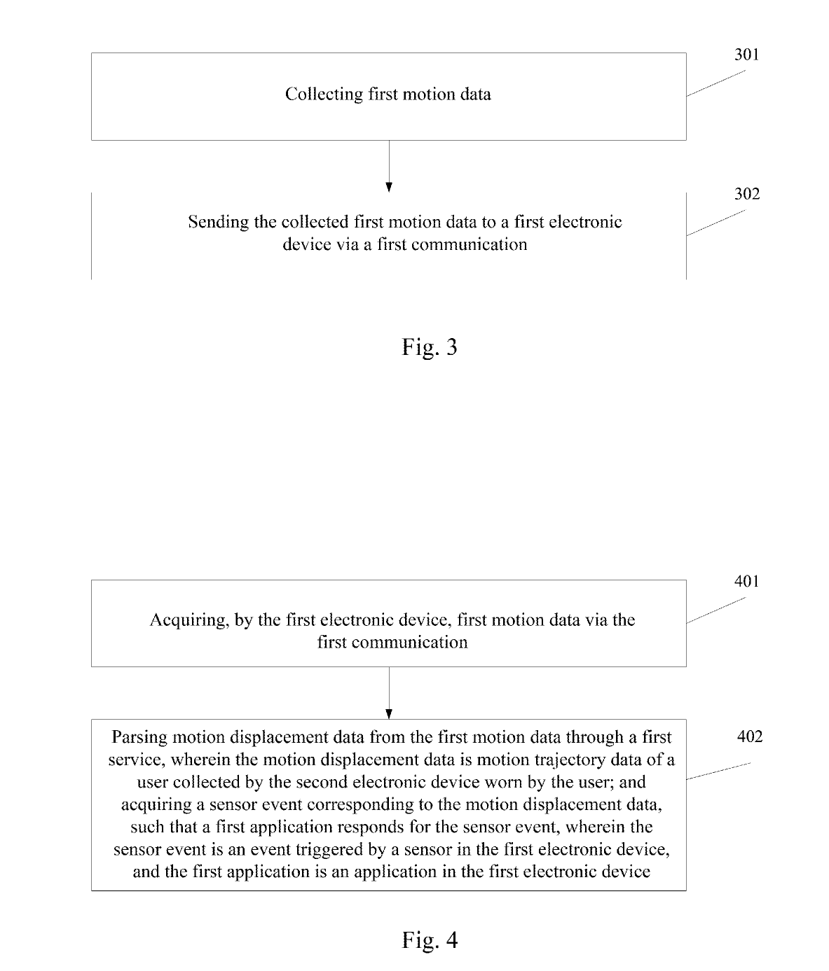

FIG. 3 is a flowchart of a second embodiment of an information processing method applied to a second electronic device. As shown in FIG. 3, the method comprises:

Step 301: Collecting first motion data. Herein, smart shoes are taken as an example for the second electronic device. When a user performs a stepping action (motion-sensing operation), the smart shoes collect data of this action.

Step 302: Sending the collected first motion data to a first electronic device via a first communication. Herein, the collected action data is sent to the first electronic device via the first communication.

In the second embodiment of the information processing method applied to the first electronic device according to the present invention, the first electronic device is capable of performing a first communication wirelessly with a second electronic device via BLUETOOTH or WiFi. In this embodiment, the first electronic device can respond to a motion-sensing operation sent by the second electronic device without the need to modify the application run in the first electronic device.

FIG. 4 is a schematic implementation flowchart of a second embodiment of an information processing method applied to a first electronic device according to the present invention. As shown in FIG. 4, the method comprises:

Step 401: acquiring, by the first electronic device, first motion data via the first communication. Herein, a wearable electronic device, such as smart shoes, is taken as an example for a second electronic device. When the smart shoes collect motion data generated from a user's stepping motion, the smart shoes send the collected first motion data to the first electronic device via BLUETOOTH or WiFi communication established between the smart shoes and the first electronic device. The first electronic device receives the first motion data. The first motion data comprises at least the direction and velocity, or the direction and acceleration of the user's step motion.

Step 402: Parsing motion displacement data from the first motion data through a first service, wherein the motion displacement data is motion trajectory data of a user collected by the second electronic device worn by the user; and acquiring a sensor event corresponding to the motion displacement data, such that a first application responds to the sensor event, wherein the sensor event is an event triggered by a sensor in the first electronic device, and the first application is an application in the first electronic device. Herein, the motion displacement data comprises at least the direction and the radius of a motion.

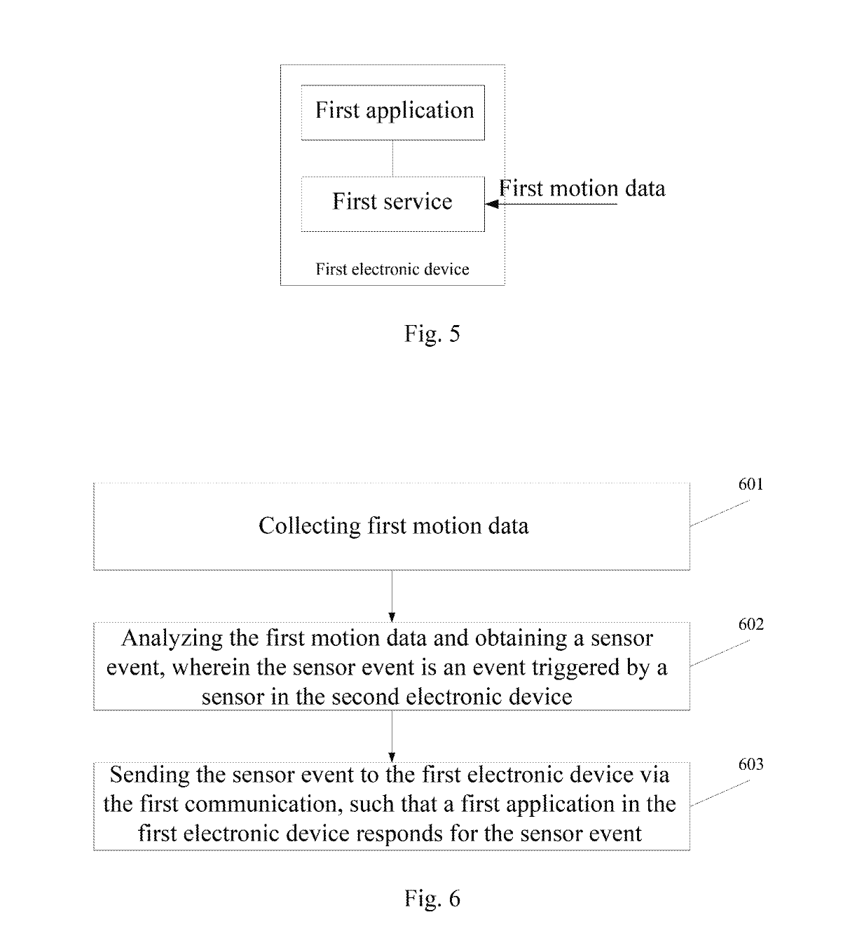

As shown in FIG. 5, a first service and a first application may run in a first operating system in the first electronic device. The first electronic device analyzes first motion data through the first service and generates a sensor event. Further, at least which foot is in motion, the motion direction of this foot, and the motion radius of this foot in the motion direction are determined in the first motion data to obtain an analysis result; and a sensor event corresponding to the analysis result is searched in a first preset relationship (as shown in Table 1 below), and it is determined that the found sensor event is a sensor event generated by the second electronic device. This sensor event may be seen as an operational event (e.g., swipe upward/downward or swipe leftward/rightward) for the first application. The first application detects this sensor event and responds accordingly. Because one or more applications may run in the first electronic device, the first application may preferably be an application running at top level. Those skilled in the art would know that the application running at top level is an application displayed on a display interface of the first electronic device. As shown in FIG. 5, the first service and the first application are independent from each other, being advantageous in that the analysis of the first motion data is performed in the first service, and the first application only needs to detect the sensor event obtained through the analysis in the first service and responds accordingly, thereby avoiding unnecessary upgrading or modification of the first application.

TABLE 1

| user's step | | sensor |
|---|---|---|
| motion | analysis of first movement data | event |
| one foot | left or right foot completely off the ground, | (vertically) |
| step | step forward with a radius of more than 20 | swipe |
| forward | cm; then the corresponding foot may or may | upward |
| | not return to its original place | |
| one foot | left or right foot completely off the ground, | (vertically) |
| step | step backward with a radius of more than 20 | swipe |
| backward | cm; then the corresponding foot may or may | downward |
| | not return to its original place | |
| left foot | left foot completely off the ground, step | (horizontally) |
| step | leftward with a radius of more than 20 cm; | swipe |
| leftward | then left foot may or may not return to its | leftward |
| | original place | |
| right foot | right foot completely off the ground, step | (horizontally) |
| step | rightward with a radius of more than 20 cm; | swipe |
| rightward | then right foot may or may not return to its | rightward |
| | original place | |

Sensors in the first electronic device include, but are not limited to, an acceleration sensor, a gyroscope, an electronic compass, etc. The first electronic device analyzes second motion data, determines one or more corresponding sensors in the first electronic device, and generates sensor events corresponding to the one or more sensors respectively. Each sensor has a different function. A sensor may only be able to detect a particular motion parameter. For example, a gyroscope is used for sensing a step's motion direction and an acceleration sensor is used for sensing a step's acceleration. However, neither the gyroscope nor the acceleration sensor has a function of detecting both the motion direction and the acceleration. Therefore, with respect to the first electronic device, generation of a sensor event is triggered when the gyroscope detects the motion direction parameter in the first motion data, wherein this sensor event may be seen as a direction operation for the first application on a display screen; generation of a sensor event is triggered when the acceleration sensor detects the acceleration parameter in the first motion data, wherein this sensor event may be seen as an operation of the radius for the first application on a display screen. The first application responds to these sensor events simultaneously.

In a preferred embodiment, after generating a sensor event, the method further comprises: injecting the generated sensor event into a first operating system, wherein the first operating system is an operating system run in the first electronic device; and detecting, by the first application run in the first operating system, the sensor event and responding accordingly.

The first operating system may be Android or IOS. There is at least one sensor injection method regarding each operating system. Taking Android as an example, a first method is to inject a sensor event into the operating system by using Monkey, a built-in tool in Android. Based on the analysis result of the first motion data, a first service running in a first electronic device sends a preset instruction to Monkey. For example, when the first motion data is an action of ‘one foot step forward’ by a user, five successive commands consisting of one ‘touch down (x, y)’, three ‘touch move (x, y)’ and one ‘touch up (x, y)’ are sent to Monkey in sequence, wherein the commands are preset to form an instruction used to represent the action of ‘one foot step forward’, wherein (x, y) are coordinates for simulating the action of ‘one foot step forward’, and ‘touch down/move/up’ are command formats. A sensor event is obtained according to these commands. This sensor event corresponds to an operational event of ‘(vertically) swipe upward’ on a touch screen simulated by the first electronic device. The Monkey inputs the simulated operational event to an input subsystem of Android's Framework by using an internal application programming interface (API) of the Framework. The first application detects this sensor event and responds accordingly. A second method is to inject a sensor event by using Input, a built-in tool of Android. Each motion-sensor action of a user is simulated with a command in Input. For example, for ‘one foot step forward’, a sensor event used to represent ‘(vertically) swipe upward’ on a touch screen may be generated by executing a command ‘input swipe (x1, y1) (x2, y2)’, wherein (x1, y1) and (x2, y2) are coordinates for simulating motion-sensing actions of the user, and ‘input swipe’ is a command format. Input injects this sensor event into an input subsystem of Android's Framework by using an internal API interface of the Framework. The first application detects this sensor event and responds accordingly. The first application does not distinguish between whether the sensor event originates from a real operation on the touch screen or from a motion-sensing operation. Therefore, motion-sensing operations can be performed to the first application in the first electronic device through a wearable electronic device without the need to modify the first application, and the method achieves the same effect as when an operation to the first application is performed through the touch screen directly.

In an embodiment, the method further comprises: when a second application in the first electronic device is an application running at top level, the second application responds to the sensor event when the sensor event is detected, wherein the second application is different from the first application. Because multiple applications may simultaneously run in the first electronic device, the first application cannot always run at top level. In this case, when a second application, being different from the first application, switches from running in the background to top level, the second application can also detect a sensor event, and respond accordingly. That is, in this solution, the application that can respond to a sensor event may be any application running in the first electronic device; this method applies to numerous types of applications without modifying the applications.

In an embodiment, the first electronic device receives and analyzes the first motion data acquired via the first communication with the second electronic device, parses motion displacement data from the first motion data through the first service, and acquires the sensor event corresponding to the motion displacement data, such that the first application detects the sensor event and responds accordingly. It can be seen that the first electronic device according to an embodiment converts the motion data of the user to a sensor event used to represent a corresponding touch operation for the first application. For the first application, the sensor event is equivalent to a touchscreen operation the user initiates directly on the display screen of the first electronic device. Therefore, the first application can detect the sensor event correctly and respond without the need to modify or upgrade the first application. Unnecessary developments to the applications can be avoided, thereby providing a more robust implementation and a more feasible practice.

### Embodiment 3

In the above Embodiments 1 and 2, the process of analyzing motion data and obtaining a sensor event is performed in the first electronic device, and the second electronic device, i.e., the wearable electronic device, is only responsible for collecting and sending first motion data. Alternatively, the process of analyzing motion data and obtaining a sensor event may be performed by the wearable electronic device, and the first electronic device is only responsible for receiving the sensor event, such that the first application running in the first electronic device detects the sensor event and responds accordingly. Details are provided as follows:

In a third embodiment of an information processing method applied to a second electronic device, the second electronic device is capable of performing a first communication wirelessly with a first electronic device via BLUETOOTH or WiFi. The second electronic device may be a wearable electronic device.

FIG. 6 is a schematic implementation flowchart of a third embodiment of an information processing method applied to a second electronic device according to the present invention. As shown in FIG. 6, the method comprises:

Step 601: Collecting first motion data. Herein, smart shoes are taken as an example for the second electronic device. When a user performs a stepping action (motion-sensing operation), the smart shoes collect data of this action.

Step 602: analyzing the first motion data and obtaining a sensor event, wherein the sensor event is an event triggered by a sensor in the second electronic device.

That the second electronic device analyzes the first motion data and obtains a sensor event comprises: the second electronic device collects and parses motion displacement data from the first motion data, wherein the motion displacement data is motion trajectory data of a user collected by the second electronic device worn by the user; and acquires, according to a first preset relationship, a sensor event corresponding to the motion displacement data. Further, at least which foot is in motion, the motion direction of this foot, and the motion radius of this foot in the motion direction are determined in the first motion data to obtain an analysis result; and a sensor event corresponding to the analysis result is searched in a first preset relationship (as shown in Table 1 previously), and it is determined that the found sensor event is a sensor event generated by the second electronic device. This sensor event may be seen as an operational event run in the first electronic device (e.g., swipe upward/downward or swipe leftward/rightward) for the first application. The first application in the second electronic device detects the sensor event and responds accordingly.

In an embodiment, the step of analyzing the first motion data and generating a sensor event comprises: analyzing the first motion data, determining one or more corresponding sensors in the first electronic device, and generating sensor events corresponding to the one or more sensors respectively. Sensors in the second electronic device include, but are not limited to, an acceleration sensor, a gyroscope, an electronic compass, etc. Each sensor has a different function. A sensor may only be able to detect a particular motion parameter. For example, a gyroscope is used for sensing a step's motion direction and an acceleration sensor is used for sensing a step's acceleration. However, neither the gyroscope nor the acceleration sensor has a function of detecting both the motion direction and the acceleration. Therefore, with respect to the second electronic device, a generation of a sensor event is triggered when the gyroscope detects the motion direction parameter in the first motion data, wherein this sensor event may be seen as a direction operation for the first application on a display screen; generation of a sensor event is triggered when the acceleration sensor detects the acceleration parameter in the first motion data, wherein this sensor event may be seen as an operation of the radius for the first application on a display screen. The second electronic device sends these sensor events to the first electronic device. The first application in the first electronic device detects these sensor events and responds accordingly.

Step 603: Sending the sensor event to the first electronic device via the first communication, such that a first application in the first electronic device responds to the sensor event accordingly.

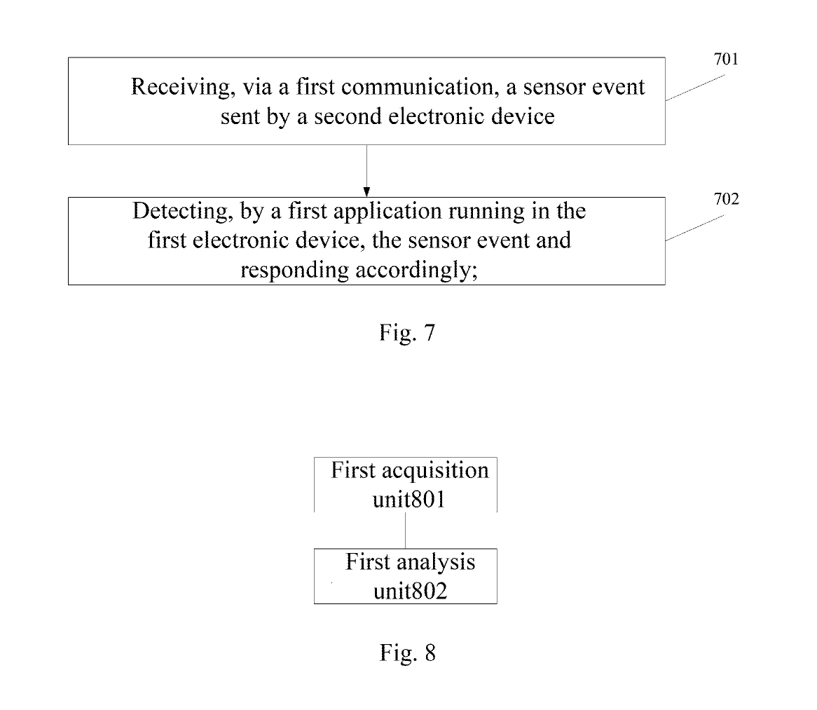

FIG. 7 is a schematic implementation flowchart of a third embodiment of an information processing method applied to a first electronic device according to the present invention. As shown in FIG. 7, the method comprises:

Step 701: Receiving, via a first communication, a sensor event sent by a second electronic device. Herein, the first electronic device receives the sensor event sent by the second electronic device wirelessly, such as BLUETOOTH or WiFi.

Step 702: Detecting, by a first application running in the first electronic device, the sensor event. and responding accordingly. Herein, the sensor event corresponds to an operational event (e.g., swipe upward/downward or swipe leftward/rightward) generated by a user to the first application on a display screen. The first application detects the sensor event and responds accordingly.

In an embodiment, the second electronic device collects, analyzes motion data, and obtains a sensor event, and sends the sensor event to the first electronic device via the first communication; the first application in the first electronic device detects the sensor event and responds accordingly. It can be seen that according to an embodiment, the conversion from motion data of a user to a sensor event occurs in the second electronic device, and the first electronic device where the first application runs only needs to detect the sensor event and responds accordingly, without the need to modify or upgrade the first application. Unnecessary developments to the applications can be avoided, thereby providing a more robust implementation and a more feasible practice.

### Embodiment 4

In an embodiment of a first electronic device, the first electronic device is capable of performing a first communication wirelessly with a second electronic device via BLUETOOTH or WiFi. In this embodiment, the first electronic device can respond to a motion-sensing operation sent by the second electronic device without the need to modify the application run in the first electronic device.

FIG. 8 is a schematic structural diagram of an embodiment of a first electronic device. As shown in FIG. 8, the first electronic device comprises a first acquisition unit 801 and a first analysis unit 802.

The first acquisition unit 801 is configured to acquire first motion data via the first communication.

The first analysis unit 802 is configured to analyze the first motion data and generate a sensor event, such that a first application responds to the sensor event, wherein the sensor event is an event triggered by a sensor in the first electronic device, and the first application is an application in the first electronic device.

When a second application in the electronic device is an application running at top level, the second application is configured to detect the sensor event and responds accordingly, wherein the second application is different from the first application.

The first electronic device runs a first service, and the first analysis unit 802 is configured to analyze the first motion data through the first service, and is further configured to: parse motion displacement data from the first motion data, wherein the motion displacement data is motion trajectory data of a user collected by the second electronic device worn by the user; and to acquire, according to a first preset relationship, a sensor event corresponding to the motion displacement data.

The first analysis unit 802 is further configured to analyze the first motion data, determine one or more corresponding sensors in the first electronic device, and generate sensor events corresponding to the one or more sensors respectively.

The first electronic device further comprises a first injection unit (not shown in FIG. 8), configured to inject the generated sensor event into a first operating system, wherein the first operating system is an operating system run in the electronic device; and the first application that runs in the first operating system detects the sensor event and responds accordingly.

It can be seen that the first electronic device, according to this embodiment, converts the user's motion data to the sensor event. For the first application, the sensor event is equivalent to a touchscreen operation the user initiates directly on the display screen of the first electronic device. Therefore, the first application can detect the sensor event correctly and respond without the need to modify or upgrade the first application. Unnecessary developments to the applications can be avoided, thereby providing a more robust implementation and a more feasible practice.

### Embodiment 5

In an embodiment of a second electronic device according to the present invention, the second electronic device is capable of performing a first communication wirelessly with a second electronic device via BLUETOOTH or WiFi.

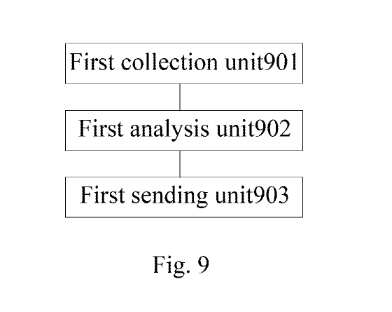

FIG. 9 is a schematic structural diagram of an embodiment of a second electronic device according to the present invention. As shown in FIG. 9, the second electronic device comprises: a first collection unit 901, a first analysis unit 902, and a first sending unit 903.

The first collection unit 901 is configured to collect first motion data. The first analysis unit 902 is configured to analyze the first motion data and obtain a sensor event, wherein the sensor event is an event triggered by a sensor in the electronic device. The first sending unit 903 is configured to send the sensor event to the first electronic device via the first communication, such that a first application in the first electronic device responds to the sensor event.

The first analysis unit 902 is further configured to parse motion displacement data from the first motion data, wherein the motion displacement data is motion trajectory data of a user collected by the electronic device worn by the user; and to acquire, according to a first preset relationship, a sensor event corresponding to the motion displacement data.

The first analysis unit 902 is further configured to analyze the first motion data, determine one or more corresponding sensors in the electronic device, and generate sensor events corresponding to the one or more sensors respectively.

In an embodiment, the second electronic device collects, analyzes motion data, and obtains a sensor event, and sends the sensor event to the first electronic device via the first communication; the first application in the first electronic device detects the sensor event and responds accordingly. It can be seen that according to an embodiment, the conversion from motion data of a user to a sensor event occurs in the second electronic device, and the first electronic device where the first application runs only needs to detect the sensor event and responds accordingly, without the need to modify or upgrade the first application. Unnecessary developments to the applications can be avoided, thereby providing a more robust implementation and a more feasible practice.

It should be noted that, in order to implement the information processing methods according to the embodiments 1 to 3, embodiments further provide a first electronic device and a second electronic device. Because the principles of how the first electronic device and the second electronic device solve the problems are similar to those of the above methods, the implementation and principles of the first electronic device and the second electronic device will not be repeated herein. For details, references can be made to the description of the implementation and principles of the methods according to the above embodiments 1 to 3.

Those skilled in the art would understand that the embodiments of the present invention may be provided as methods, systems, or computer program products. The present invention may take the form of a hardware embodiment, a software embodiment or an embodiment combining software and hardware aspects. In addition, the present invention may take the form of a computer program product embodied on one or more computer-usable storage media (including, but not limited to, disk storage, optical storage, and so forth) having computer-usable program code embodied therein.

The present invention has been described with references to flow diagrams and/or block diagrams of methods, devices (systems), and computer program products according to embodiments of the present invention. It should be understood that each flow and/or block of the flow diagrams and/or block diagrams, and combinations of flows and/or blocks in the flow diagrams and/or block diagrams, can be implemented by computer program instructions. The computer program instructions may be provided for a general-purpose computer, a special computer, an embedded processor or another device of programmable data processing to produce a machine, which, through the instructions executed by a processor of a computer or another device of programmable data processing, enables producing devices for implementing functions indicated in one or more flows in flow diagrams and/or one or more blocks in block diagrams.

The computer program instructions may also be stored in a computer-readable storage, which can guide a computer or another device of programmable data processing to operate in a specific manner, such that the instructions stored in the computer-readable storage produce a product containing an instruction device. The instruction device implements the functions indicated in one or more flows in flow diagrams and/or one or more blocks in block diagrams. In the context of this document, a computer-readable storage is not a signal and “non-transitory” includes all media except signal media.

These computer program instructions may also be loaded onto a computer or another device of programmable data processing, such that a series of operational steps are executed in the computer or the device of programmable data processing to produce computer-implemented processing. In this way, the instructions executed on the computer or the device of programmable data processing are provided for implementing the steps of the functions indicated in one or more flows in flow diagrams and/or one or more blocks in block diagrams.

The foregoing embodiments are merely example embodiments, and are not intended to limit the protection scope of the disclosure.

What is claimed is:

1. A method, comprising:
receiving, at an electronic device, data from a wearable device;
detecting that the received data relate to a sensor event of at least one sensor of the electronic device, the sensor event being generated and operable to effect an operation of the electronic device via an operating system of the electronic device; and
effecting the operation of the electronic device based on the sensor event via the operating system.

2. The method according to claim 1, wherein when an application in the electronic device is an application running at top level, the method further comprises:
responding, by the application, to the generated sensor event, wherein the application is different from the operating system.

3. The method according to claim 1, wherein the electronic device runs a service and analyzes motion data through the service;
the analyzing of the motion data through the service further comprises:
parsing motion displacement data from motion data, wherein the motion displacement data is motion trajectory data of a user collected by the wearable device;
acquiring, according to a first preset relationship, the sensor event corresponding to the motion displacement data.

4. The method according to claim 1, further comprising:
analyzing the data, determining one or more corresponding sensors in the electronic device, and generating sensor events corresponding to the one or more sensors respectively.

5. The method according to claim 1, further comprising:
injecting generated sensor events into the operating system;
detecting, by an application run in the operating system, the sensor events and responding accordingly.

6. The method according to claim 1, wherein the detecting comprises deriving the sensor event based on the received data.

7. The method according to claim 1, wherein the received data comprises motion data.

8. An electronic device, comprising:
a processor;
a memory device that stores an operating system comprising instructions executable by the processor;
at least one sensor coupled to the processor, the at least one sensor being operable to generate a sensor event to the operating system in order to effect an operation of the electronic device; and
a receiver coupled to the processor, the receiver being configured to receive data from a wearable device,
wherein the instructions executable by the processor comprise instructions executable by the processor to detect that the data received from the receiver relate to the sensor event of the at least one sensor, and to effect the corresponding operation of the electronic device based on the sensor event via the operating system.

9. The electronic device of claim 8, wherein the receiver is configured to receive motion data from the wearable device, and the instructions executable by the processor derive the sensor event based on the received data.

10. The electronic device of claim 8, wherein the receiver is configured to receive a sensor event from the wearable device, and the instructions executable by the processor effect the corresponding operation of the electronic device based on the received sensor event.

11. The electronic device according to claim 8, wherein when an application in the electronic device is an application running at top level, the application responds to the generated sensor event, wherein the application is different from the operating system.

12. The electronic device according to claim 8, wherein the electronic device runs a first service, and a first analysis unit analyzes the data via a first service;
the first analysis unit parses motion displacement data from the data, wherein the motion displacement data is motion trajectory data of a user collected by the wearable device; and acquires, according to a first preset relationship, the sensor event corresponding to the motion displacement data.

13. The electronic device according to claim 8, further comprising:
instructions executable by the processor to analyze the data, determine one or more corresponding sensors in the electronic device, and generate sensor events corresponding to the one or more sensors respectively.

14. The electronic device according to claim 8, wherein the electronic device further comprises:
a first injection unit, which injects generated sensor events into the operating system;
an application run in the first operating system, the sensor events and responding accordingly.

15. A wearable device, comprising:
a processor;
a motion sensor operatively connected to the processor, the motion sensor collating motion data of the wearable device;
a transmitter operatively connected to the processor, the transmitter transmitting data to an electronic device; and
a memory device that stores instructions executable by the processor to:
generate a sensor event based on the collated motion data, wherein the sensor event is of a type of sensor event that is processed by the electronic device; and
transmit the sensor event to the electronic device.

16. The wearable device according to claim 15, wherein the instructions are further executable to:
parse motion displacement data from the motion data, wherein the motion displacement data is motion trajectory data of a user collected by the wearable device; and
identify a sensor event corresponding to the motion displacement data according to a preset relationship.

17. The wearable device according to claim 16, wherein the instructions are further executable to:
analyze the motion data;
identify one or more corresponding sensors in the electronic device; and
generate sensor events corresponding to the one or more sensors.

18. The wearable device according to claim 15, wherein the transmitted data are used to derive the sensor event

19. The wearable device according to claim 18, wherein the derived sensor event effects operation of an electronic device.

20. The wearable device according to claim 15, wherein the motion data includes motion trajectory data.
